(19) United States
(12) Patent Application Publication
(10) Pub. No.: US 2002/0118701 A1
(43) Pub. Date: Aug. 29, 2002

(54) Method of synchronizing data on a serial link

(75) Inventors: Marc Wallois, Montesson (FR); Frederic Hochedez, Rueil-Malmaison (FR); Eric Valade, Sarge les le Mans (FR)

Correspondence Address: SUGHRUE MION, PLLC, 2100 Pennsylvania Avenue, NW, Washington, DC, 20037-3213, US

(73) Assignee: ALCATEL

(21) Appl. No.: 10/026,439

(22) Filed: Dec. 27, 2001

(30) Foreign Application Priority Data
Jan. 2, 2001 (FR) 01 00 002

(51) Int. Cl. H04J 3/16

(52) U.S. Cl. 370/465; 370/503

(57) ABSTRACT

The invention proposes a method of synchronizing data between a computer and a portable appliance over a serial link. The computer sends a change-of-protocol AT command to the appliance to specify a proprietary protocol for use in synchronization. The appliance sends a response to change over to the specified proprietary protocol. The data in the computer and the appliance is then synchronized using the proprietary protocol. The invention also provides a portable appliance having a serial port, an AT interpreter interpreting commands received over the serial port until a change-of-protocol command is received, and a proprietary synchronization protocol interpreter interpreting the commands received over the serial link after a change-of-protocol command has been received. The invention enables data to be synchronized between a computer and a portable appliance using a standard serial link and without using proprietary interfaces.

The invention relates to using a serial link to synchronize data between a computer and a portable appliance, and more particularly to synchronizing data between an office computer and a portable organizer or telephone terminal.

### BACKGROUND OF THE INVENTION

It is becoming more and more frequent for data to be transferred between an office computer and a portable appliance, such as an organizer or a mobile telephone. Data can be modified, deleted, or created on either appliance. The data contained in each of the organizers then differs depending on what action has been taken thereon, so it becomes necessary to synchronize the data. By way of example, synchronization can comprise a step consisting in replacing an old version of a file contained in an office computer by an updated version contained in a portable organizer. Synchronization can also relate to updating data internal to a file, such as fields in a file corresponding to an application. Synchronization can thus relate to addresses in a database of a dialing list. Synchronization can also comprise a step which consists in deleting or adding a file that has been deleted or added solely on the computer or on the portable organizer.

Document U.S. Pat. No. 5,666,530 discloses putting an office computer into communication with a portable computer in automatic manner. Synchronization can be programmed to take place at a predetermined time. A clock contained in a chip of the portable computer triggers synchronization when the determined time is reached. The office computer and the portable computer both have respective modems and they can be put into communication via a telephone network. That document also envisages interconnecting the computers via parallel ports, serial ports, or by wireless. The versions of the same files contained both on the portable computer and on the office computer are compared. Once differences have been identified between versions of the same files, then the user is questioned to discover whether communication should be established automatically. With the user's approval, identical versions of any given file are stored both in the office computer and in the portable computer.

Document WO 99/22324 also discloses programming a request for a rendezvous from a portable computer. The portable computer is put into communication with an office computer via a serial cable link, an infrared link, network cards, or a wireless modem. The request can be used as a basis for sending out notices by email, for example. The portable object generates an object representative of the request for a rendezvous and gives it an ID number so that it can be identified uniquely by other appliances, such as workstations, with which the computer is put into communication.

Nevertheless, those documents do not describe how to synchronize data without adding proprietary interfaces in each terminal. Nor do those documents describe what protocols can be used to achieve synchronization.

It is also known to transmit data via a modem using an AT protocol. That protocol is subject to a nomenclature under references ITU-T V25ter and ETSI TS GSM V7.07. Unfortunately, that protocol is not well adapted to synchronizing data.

### OBJECTS AND SUMMARY OF THE INVENTION

There therefore exists a need for a method and a portable appliance enabling data to be synchronized without that requiring the addition of specific interfaces. The invention thus provides a method of synchronizing data between a computer and a portable appliance interconnected by a serial link, the method comprising the steps of: the computer using an AT protocol to send a command over the serial link to cause protocol to be changed by specifying a proprietary protocol to be used for synchronization purposes; the portable appliance sending a response to the computer indicating that it has changed to the specified proprietary synchronization protocol; and the data in the portable appliance and the computer is synchronized using the specified proprietary synchronization protocol.

In a variant, after the synchronization step, the synchronization method further comprises a step of: the portable appliance sending an AT command to the computer indicating that it has changed to AT protocol.

In another variant, the proprietary synchronization protocol is a packet transmission protocol.

In yet another variant, the protocol changeover command is an AT+CPROT command.

Preferably, prior to the step of the computer sending a change-of-protocol command, the synchronization method comprises the steps of the computer sending an AT command interrogating the portable appliance about the proprietary protocols accepted by the portable appliance; and the portable appliance sending a response to the computer specifying the accepted proprietary protocols.

In another variant, the portable appliance is a mobile telephone terminal.

In yet another variant, the portable appliance is an organizer.

The invention also provides a portable appliance presenting: a serial port; an AT interpreter interpreting commands received over the serial link until a change-of protocol command is received; and a proprietary synchronization protocol interpreter interpreting commands received over the serial port after a change-of protocol command.

In a variant of this portable appliance, the proprietary synchronization protocol is a packet transmission protocol.

In another variant, the change-of-protocol command is an AT+CPROT command.

In another embodiment, the portable appliance is a mobile telephone terminal.

In yet another embodiment, the portable appliance is an organizer.

### BRIEF DESCRIPTION OF THE DRAWINGS

Other characteristics and advantages of the invention will appear on reading the following description of embodiments given by way of example and with reference to the drawings, in which:

FIG. 1 is a diagram showing a computer and a portable appliance interconnected by a serial cable;

FIG. 2 is a flow chart showing the steps in a transmission method constituting an implementation of the invention; and

FIG. 3 is a diagram showing elements of a portable appliance in accordance with the invention.

### MORE DETAILED DESCRIPTION

The invention provides a method of synchronizing data between a computer and a portable appliance via a standard serial link. For this purpose, a standard transmission protocol is used to send commands over the serial link in order to specify a proprietary transmission protocol for subsequent use for synchronization purposes.

Implementations and embodiments of the invention are described below.

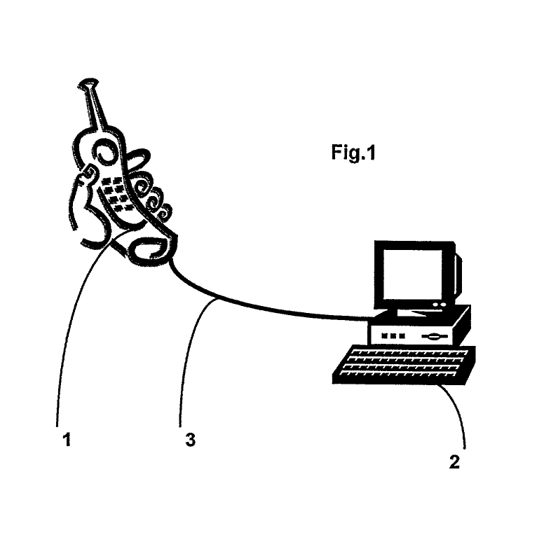

FIG. 1 shows a mobile telephone terminal 1 connected to a computer 2 via a serial link 3. The serial link 3 is adapted to sending commands using an AT protocol. The portable terminal and the computer both contain data that needs to be synchronized, for example a list of telephone numbers or files. It can happen that the data is modified on the portable terminal and not on the computer, or vice versa. The data is synchronized via the serial link 3 in the manner described below. The serial link can be implemented, for example, by means of a standard serial cable connected to two respective serial ports of the computer 2 and of the portable terminal 1. Furthermore, the methods described below use commands of a standard AT protocol at the beginning of communication between the portable terminal and the computer. Computers and portable appliances provided with serial links are commonly themselves provided with respective AT interpreters.

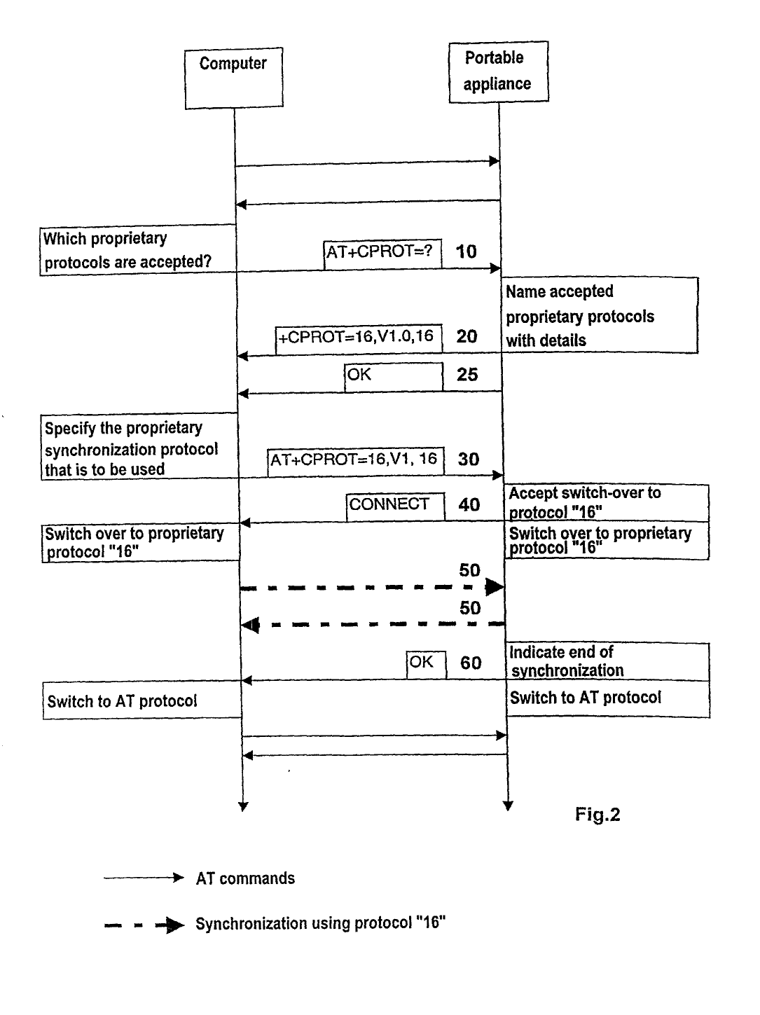

FIG. 2 is a flow chart of a method for synchronizing data between a computer and a portable appliance in accordance with the invention. The computer and the portable terminal can communicate initially by using commands from an AT protocol.

Optionally, the synchronization method of the invention can advantageously present a step of interrogating the portable appliance concerning the proprietary synchronization protocols that are accepted by the appliance, with this being done by the computer sending a command 10. The method can then present a step in which the portable appliance replies by means of a command 20, this command specifying which proprietary protocols it accepts.

In a first step, the computer sends an AT command 10 over the serial link 3. This AT command interrogates the portable appliance concerning the proprietary synchronization protocols which the portable appliance can accept. The command used can be a command of the type:

AT+CPROT=?

Thus, by way of example, the computer can select amongst the acceptable protocols as a function of which protocols it can accept itself.

The portable appliance replies in the following step by means of an AT command 20 sent over the serial link 3 indicating one or more acceptable proprietary protocols for synchronization. By sending a list of acceptable proprietary synchronization protocols in its response, the portable appliance enables the computer to determine amongst those protocols which is the protocol it finds the most appropriate for synchronizing data.

By default, the command sent in response can have the following form:

+CPROT:X, Y, Z

where X, Y, and Z are parameters of the command.

When a list of accepted proprietary protocols is sent, it takes the form of a stream of +CPROT: commands having the following forms:

+CPROT:X, Y, Z

+CPROT:X′, Y′, Z′

+CPROT:X″, Y″, Z″

The portable appliance can send an OK command 25 at the end of the list of accepted proprietary protocols to mark the end of its responses.

The parameter X identifies a proprietary protocol accepted by the portable appliance. For example it can identify a packet transmission protocol.

The parameter Y identifies in this case the version of the accepted proprietary synchronization protocol. This parameter is optional and need not be sent to the computer.

The parameter Z indicates an application protocol accepted by the portable appliance. This term is likewise optional.

In the example of FIG. 2, the portable appliance sends the following response in its command 20:

+CPROT:16, “V1.0”,16

This command should be read as follows: protocol 16 is accepted; the accepted version of this protocol is version “1.0”; application protocol 16 is accepted.

The parameter X in the response command enables the computer to determine which proprietary synchronization protocol can be used in the following step. The parameter Y enables the computer to decide which version of the proprietary synchronization protocol can be used. This makes it possible advantageously to avoid conflicts between versions of the protocols as accepted by the computer and by the portable appliance. The parameter Z can be used, for example, to specify the application protocol that is available in the portable appliance.

After receiving the response message, the computer can select a protocol that is accepted both by itself and by the portable appliance. Steps 10 and 20 can be omitted if the computer and the portable appliance are known to each other; this can be the case if synchronization has already been performed between them.

In the following step, the computer sends an AT command 30 over the serial link specifying the proprietary protocol that is to be used for synchronization. This command can be a function of the result of optional command 20 or it can be the result of the computer already knowing the portable appliance. This AT command 30 can have the following form:

AT+CPROT=X, Y, Z

The parameters X, Y, and Z have the same meanings as defined for the command 20. The parameter X thus makes it possible to specify which proprietary protocol to use. Optional parameter Y serves to specify the version of the proprietary protocol that is to be used. Optional parameters Z serve to specify the application protocol to be used.

In the example of FIG. 2, the computer sends the following command 30:

AT+CPROT=16, “V1.0”,16

This command is read as follows: protocol 16 is to be used; the version of this protocol that is to be used is version “1.01”; application protocol 16 is to be used.

The portable appliance thus receives an AT command 30 telling it to change to a specific proprietary synchronization protocol.

In the following step, the portable appliance issues an acceptance 40 stating that it accepts the specified proprietary synchronization protocol. The following AT command can be used for this purpose:

CONNECT

This acceptance acts as an acknowledgment for the computer. The protocol used thereafter is the synchronization protocol.

In the event of the steps of sending commands 10 and 20 not being performed, the lack of a response 40 can act as a signal for abandoning communication between the computer and the portable appliance. When the portable appliance is not in a position to use the protocol specified by the command 30, it can reply with an ERROR command.

The method then moves on to the step of synchronizing data proper. In this step, data is synchronized using the proprietary protocol. Data frames 50 are then sent between the portable appliance and the computer. The proprietary protocol used can be a packet synchronization protocol.

When it is desired to continue transmission between the portable appliance and the computer after synchronization has terminated, it is possible to return to AT protocol. The portable appliance can thus send an AT command 60 to the computer marking a return to AT protocol. It is thus possible to use the following AT command to mark the return to AT protocol: OK

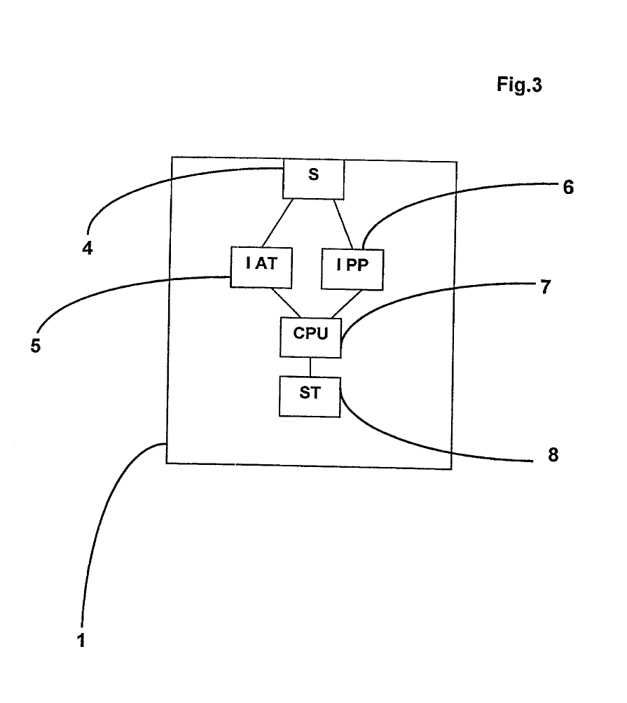

The invention also provides a portable appliance. FIG. 3 is a diagram showing elements of a portable appliance of the invention. Such an appliance comprises a serial port 4, connected to an AT interpreter 5 and to a proprietary synchronization protocol 6. The appliance also has a processor 7 for switching between interpreters. The processor is connected to a data storage member 8 which can be constituted by a memory card, for example.

The portable appliance can make the AT interpreter and the proprietary synchronization interpreter active in alternation in order to interpret commands. The interpreters serve to send and receive commands specific to their own protocol over the serial port whenever they are active. The serial port enables a connection to be made by means of a serial cable between a computer and some other appliance that is portable. It is also possible to envisage providing the serial link using other types of medium, for example by using a wireless link or an infrared link.

The operation of a portable appliance of the invention can be illustrated on the basis of the method described with reference to FIG. 2. By default, the AT interpreter is active, while the proprietary protocol interpreter is passive. Thus, the AT interpreter remains active while AT commands 10, 20, 30, and 40 are being transmitted. On receiving the change-of-protocol command 30, the portable appliance sends the command 40 using the AT protocol. Thereafter the interpreters are switched over: the AT interpreter becomes passive while the proprietary synchronization interpreter becomes active. Synchronization frames 50 are then sent or received by the proprietary protocol interpreter over the serial port.

At the end of synchronization, the interpreters can switch over so as to continue transmission using the AT protocol: the AT interpreter becomes active while the proprietary synchronization interpreter becomes passive. The end-of-synchronization command 60 is then sent over the serial port using the AT protocol.

It is possible either to make use of an external command which triggers switchover between interpreters, or else to use interpreters which recognize the change-of-protocol command.

As described above, a proprietary synchronization protocol for the appliance can be a packet transmission protocol.

The embodiments and implementations described herein should be considered as being given purely by way of illustration and not as being limiting on the invention which is not limited in any way to the details provided herein but which can be modified while remaining within the context of the scope of the accompanying claims. Thus, it is also possible in the context of the invention to use proprietary synchronization protocols other than those described in detail above. It is also possible to use the synchronization method described with appliances other than an organizer or a mobile telephone terminal.

1/ A method of synchronizing data between a computer and a portable appliance interconnected by a serial link, the method comprising the steps of:
the computer using an AT protocol to send a command over the serial link to cause protocol to be changed by specifying a proprietary protocol to be used for synchronization purposes;
the portable appliance sending a response to the computer indicating that it has changed to the specified proprietary synchronization protocol; and
the data in the portable appliance and the computer is synchronized using the specified proprietary synchronization protocol.

2/ The synchronization method of claim 1, wherein, after the synchronization step, the method further comprises a step of:
the portable appliance sending an AT command to the computer indicating that it has changed to AT protocol.

3/ The synchronization method of claim 1, wherein the proprietary synchronization protocol is a packet transmission protocol.

4/ The synchronization method of claim 2, wherein the proprietary synchronization protocol is a packet transmission protocol.

5/ The synchronization method of claim 1, wherein the protocol changeover command is an AT+CPROT command.

6/ The synchronization method of claim 2, wherein the protocol changeover command is an AT+CPROT command.

7/ The synchronization method of claim 3, wherein the protocol changeover command is an AT+CPROT command.

8/ The synchronization method of claim 4, wherein the protocol changeover command is an AT+CPROT command.

9/ The synchronization method according to any preceding claim, wherein, prior to the step of the computer sending a change-of-protocol command, the method comprises the steps of:
the computer sending an AT command interrogating the portable appliance about the proprietary protocols accepted by the portable appliance; and
the portable appliance sending a response to the computer specifying the accepted proprietary protocols.

10/ A synchronization method according to any preceding claim, wherein the portable appliance is a mobile telephone terminal.

11/ A synchronization method according to any one of claims 1 to 10, wherein the portable appliance is an organizer.

12/ A portable appliance presenting:
a serial port;
an AT interpreter interpreting commands received over the serial link until a change-of-protocol command is received; and
a proprietary synchronization protocol interpreter interpreting commands received over the serial port after a change-of-protocol command.

13/ A portable appliance according to claim 12, wherein the proprietary synchronization protocol is a packet transmission protocol.

14/ A portable appliance according to claim 12, wherein the change-of-protocol command is an AT+CPROT command.

15/ A portable appliance according to claim 13, wherein the change-of-protocol command is an AT+CPROT command.

16/ A portable appliance according to claim 12, wherein the appliance is a mobile telephone terminal.

17/ A portable appliance according to claim 13, wherein the appliance is a mobile telephone terminal.

18/ A portable appliance according to claim 14, wherein the appliance is a mobile telephone terminal.

19/ A portable appliance according to claim 15, wherein the appliance is a mobile telephone terminal.

20/ A portable appliance according to claim 12, wherein the appliance is an organizer.

21/ A portable appliance according to claim 13, wherein the appliance is an organizer.

22/ A portable appliance according to claim 14, wherein the appliance is an organizer.

23/ A portable appliance according to claim 15, wherein the appliance is an organizer.
